(19) United States
(12) Patent Application Publication
(10) Pub. No.: US 2023/0261035 A1
(43) Pub. Date: Aug. 17, 2023

(54) LIGHT-EMITTING SUBSTRATE, DISPLAY PANEL, BACKLIGHT MODULE, DISPLAY DEVICE, AND DRIVING METHOD

(71) Applicant: Xiamen Tianma Micro-Electronics Co., Ltd., Xiamen (CN)

(72) Inventors: Kaiming SUN, Xiamen (CN); Xiaoming CHEN, Xiamen (CN); Guochang LAI, Xiamen (CN); Rong CHEN, Xiamen (CN); Xinyue WEN, Xiamen (CN); Yalan GUO, Xiamen (CN)

(73) Assignee: Xiamen Tianma Micro-Electronics Co., Ltd., Xiamen (CN)

(21) Appl. No.: 18/308,502

(22) Filed: Apr. 27, 2023

(30) Foreign Application Priority Data
Nov. 10, 2022 (CN) 202211407079.0

(51) Int. Cl. H01L 27/15; G02F 1/13357; G09G 3/34; G09G 3/32; H01L 25/075

(52) U.S. Cl. CPC H01L 27/156; G02F 1/133603; G09G 3/3426; G09G 3/32; H01L 25/0753; G09G 2320/0233; G09G 2320/0242

(57) ABSTRACT

A light-emitting substrate, a display panel, a backlight module, a display device and a driving method. The light-emitting substrate has a light-emitting region and includes a plurality of light-emitting elements located in the light-emitting region and configured to emit light of different colors. The plurality of light-emitting elements includes an edge light-emitting element adjacent to an edge of the light-emitting region, and a first light-emitting element adjacent to the edge light-emitting element, and the edge light-emitting element is configured to emit light of a first color, and the first light-emitting element is configured to emit light of a second color different from the first color.

### CROSS-REFERENCE TO RELATED APPLICATIONS

The present application claims priority to Chinese Patent Application No. 202211407079.0, filed on Nov. 10, 2022, the content of which is incorporated herein by reference in its entirety.

### TECHNICAL FIELD

The present disclosure relates to the technical field of display, and in particular, to a light-emitting substrate, a display panel, a backlight module, a display device, and a driving method.

### BACKGROUND

With the continuous development of science and technology, display devices are more and more widely used in people's daily life and work and have become an indispensable and important tool for people today.

The display technology that uses a small-sized light-emitting diode (LED) for display devices emerges. The small-sized LED generally refers to an LED with a size smaller than 200 μm. The small-sized LED includes a Micro LED and a Mini LED. The small-sized LED can be used as a backlight in the display device or can be used directly for displays by means of their self-luminous property. Taking the Mini LED used as a backlight in the display device as an example, compared with a liquid crystal display device using a traditional backlight, the liquid crystal display device using Mini LED backlight technology can achieve local dimming, better performance in dynamic contrast and brightness, and has the advantages of thinness, high image quality, low power consumption and energy saving, which can greatly improve the performance of liquid crystal display device. In addition, the Mini LED backlight can be combined with a flexible substrate for curved display and thin and light design, improving application flexibility of the Mini LED backlight. Therefore, small-size LED display technology has greater application prospects in various scenarios such as wearable display device, TV, computer, and vehicle display.

However, when this type of display device is displaying images, there is a problem of color shift at the edge of the display region.

### SUMMARY

In a first aspect, a light-emitting substrate is provided. The light-emitting substrate has a light-emitting region and includes a plurality of light-emitting elements located in the light-emitting region and configured to emit light of different colors. The plurality of light-emitting elements includes at least one edge light-emitting element adjacent to an edge of the light-emitting region, and a first light-emitting element adjacent to one edge light-emitting element of the at least one edge light-emitting element. The edge light-emitting element is configured to emit light of a first color, and the first light-emitting element is configured to emit light of a second color different from the first color.

In a second aspect, a display panel is provided. The display panel includes a light-emitting substrate. The light-emitting substrate has a light-emitting region and includes a plurality of light-emitting elements located in the light-emitting region and configured to emit light of different colors. The plurality of light-emitting elements includes at least one edge light-emitting element adjacent to an edge of the light-emitting region, and a first light-emitting element adjacent to one edge light-emitting element of the at least one edge light-emitting element. The edge light-emitting element is configured to emit light of a first color, and the first light-emitting element is configured to emit light of a second color different from the first color.

In a third aspect, a backlight module is provided. The backlight module includes a light-emitting substrate. The light-emitting substrate has a light-emitting region and includes a plurality of light-emitting elements located in the light-emitting region and configured to emit light of different colors. The plurality of light-emitting elements includes at least one edge light-emitting element adjacent to an edge of the light-emitting region, and a first light-emitting element adjacent to one edge light-emitting element of the at least one edge light-emitting element. The edge light-emitting element is configured to emit light of a first color, and the first light-emitting element is configured to emit light of a second color different from the first color.

In a fourth aspect, a display device is provided. The display device includes a liquid crystal display panel and a backlight module. The liquid crystal display panel is at the light-exiting side of the backlight module. The backlight module includes a light-emitting substrate. The light-emitting substrate has a light-emitting region and includes a plurality of light-emitting elements located in the light-emitting region and configured to emit light of different colors. The plurality of light-emitting elements includes at least one edge light-emitting element adjacent to an edge of the light-emitting region, and a first light-emitting element adjacent to one edge light-emitting element of the at least one edge light-emitting element. The edge light-emitting element is configured to emit light of a first color, and the first light-emitting element is configured to emit light of a second color different from the first color.

In a fifth aspect, a method for driving a display device is provided. The display device includes a liquid crystal display panel and a backlight module. The liquid crystal display panel is at the light-exiting side of the backlight module. The backlight module includes a light-emitting substrate. The light-emitting substrate has a light-emitting region and includes a plurality of light-emitting elements located in the light-emitting region and configured to emit light of different colors. The plurality of light-emitting elements includes at least one edge light-emitting element adjacent to an edge of the light-emitting region, and a first light-emitting element adjacent to one edge light-emitting element of the at least one edge light-emitting element. The edge light-emitting element is configured to emit light of a first color, and the first light-emitting element is configured to emit light of a second color different from the first color. The liquid crystal display panel includes a plurality of sub-pixels. The method includes charging one sub-pixel of the plurality of sub-pixels, and after the charging of the sub-pixel finishes, controlling one light-emitting element of the plurality of light-emitting elements in the backlight module corresponding to the sub-pixel to emit light.

### BRIEF DESCRIPTION OF DRAWINGS

In order to more clearly illustrate the technical solutions in the embodiments of the present disclosure, the accompanying drawings used in the description of the embodiments will be briefly introduced below. It is apparent that, the accompanying drawings in the following description are only some embodiments of the present disclosure, and other drawings can be obtained by those of ordinary skill in the art from the provided drawings without creative efforts.

FIG. 1 is a schematic diagram of a light-emitting substrate according to embodiments of the present disclosure.

FIG. 2 is a schematic diagram of a display device including a light-emitting substrate according to embodiments of the present disclosure.

FIG. 3 is a schematic diagram of another light-emitting substrate according to embodiments of the present disclosure.

FIG. 4 is a schematic diagram of yet another light-emitting substrate according to embodiments of the present disclosure.

FIG. 5 is a schematic diagram of another display device including a light-emitting substrate according to embodiments of the present disclosure.

FIG. 6 is a schematic diagram showing electrical connection of a partial area of a light-emitting substrate according to embodiments of the present disclosure.

FIG. 7 is a schematic diagram showing layers of a display device according to embodiments of the present disclosure.

FIG. 8 is a flowchart of a method for driving a display device according to embodiments of the present disclosure.

FIG. 9 is a schematic diagram showing a working principle of backlight partitions and display partitions corresponding to the backlight partitions of a display panel according to embodiments of the present disclosure.

FIG. 10 is a schematic diagram showing color changing of backlight partitions of a backlight module in multiple time periods according to embodiments of the present disclosure.

FIG. 11 is a schematic diagram showing a working principle of backlight partitions and display partitions corresponding to the backlight partitions according to embodiments of the present disclosure.

FIG. 12 is a schematic diagram showing a working principle of backlight partitions and display partitions corresponding to the backlight partitions according to embodiments of the present disclosure.

FIG. 13 is a schematic diagram of an i^{th} backlight partition of a backlight module according to embodiments of the present disclosure.

### DESCRIPTION OF EMBODIMENTS

For facilitating the understanding of the technical solution of the present disclosure, the embodiments of the present disclosure are described in detail as below.

It should be understood that the embodiments described below are merely some of, rather than all of the embodiments of the present disclosure. On a basis of the embodiments in this disclosure, all other embodiments obtained by the ordinary skilled in the art without paying creative effort are within a protection scope of this disclosure.

The terms used in the embodiments of the present disclosure are merely for the purpose of describing specific embodiments, but not intended to limit the present disclosure. The singular forms of “a”, “an” and “the” used in the embodiments of the present disclosure and the appended claims are also intended to indicate plural forms, unless clearly indicating others.

It should be understood that the term “and/or” used herein merely indicates a relationship describing associated objects, indicating three possible relationships. For example, the expression “A and/or B” indicates: A exists alone, both A and B exist, or B exists alone. In addition, the character “/” in this description generally means that the associated objects are in an “or” relationship.

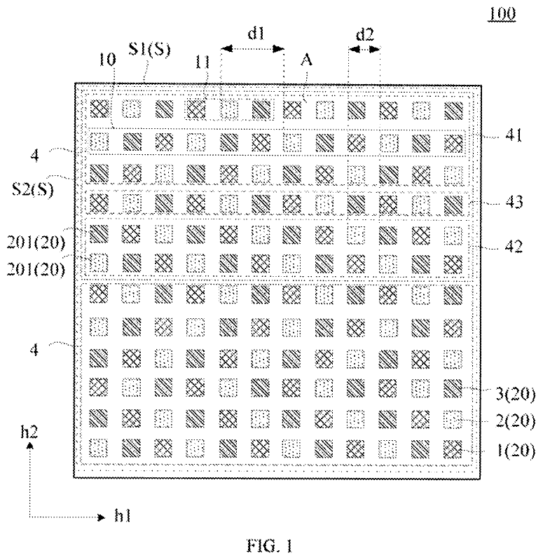

Embodiments of the present disclosure provide a light-emitting substrate. FIG. 1 is a schematic diagram of a light-emitting substrate 100 according to embodiments of the present disclosure. As shown in FIG. 1, the light-emitting substrate 100 includes a light-emitting region A. The light-emitting region A includes a plurality of types of light-emitting elements 20 configured to emit light of different colors. In some example embodiments, at least three types of light-emitting elements 20 configured to emit light of different colors are disposed in the light-emitting region A. FIG. 1 shows an example in which the plurality of light-emitting elements 20 includes a first color light-emitting element 1, a second color light-emitting element 2, and a third light-emitting element 3. A color of light emitted by the first color light-emitting element 1, a color of light emitted by the second color light-emitting element 2, and a color of light emitted by the third color light-emitting element 3 are different from each other, such that the light-emitting substrate 100 can generate various colors of lights. In FIG. 1, the light-emitting elements 20 emitting light of different colors are illustrated by different filling patterns. For example, colors of the light emitted by the first color light-emitting element 1, the second color light-emitting element 2, and the third color light-emitting element 3 are red, green, and blue respectively.

In an example embodiment, the light-emitting element 20 is any one of an organic light-emitting diode, an inorganic light-emitting diode, and a quantum dot light-emitting diode.

As shown in FIG. 1, the plurality of light-emitting elements 20 includes an edge light-emitting element 201 adjacent to an edge S of the light-emitting region A. That means the edge light-emitting element 201 is the outermost light-emitting element 20 in the light-emitting region A. In embodiments of the present disclosure, the plurality of light-emitting elements 20 includes a first light-emitting element adjacent to the edge light-emitting element 201, and the color of the light emitted by the edge light-emitting element 201 is different from the color of the light emitted by another light-emitting element 20 adjacent to the edge light-emitting element 201.

In the embodiments of the present disclosure, the arrangement of the light-emitting elements 20 in the light-emitting region A of the light-emitting substrate 100 is adjusted, the edge light-emitting element 201 and the first light-emitting element 20 adjacent to the edge light-emitting element 201 emit light of different colors. When the light-emitting substrate 100 is lit, the edge light-emitting element 201 and the first light-emitting element 20 adjacent to the edge light-emitting element 201 emit lights of different colors, and the light of different colors are blended with each other at the edge S of the light-emitting region A. When an observer views the light-emitting substrate 100, the observer sees the effect of fusion of lights of different colors at the edge S of the light-emitting region A, which can avoid that the observer sees a color shift phenomenon at the edge S of the light-emitting region A. Accordingly, the light-emitting substrate 100 provided by the embodiments of the present disclosure can improve a color blending effect at the edge S of the light-emitting region A, improve the chromaticity uniformity at the edge S of the light-emitting region A, and avoid the color shift at the edge of the light-emitting region A.

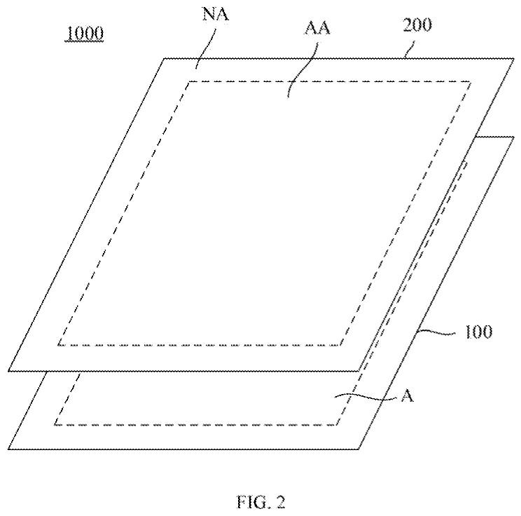

In an example embodiment, the light-emitting substrate 100 may be combined with a liquid crystal display panel to form a display device. FIG. 2 is a schematic diagram of a display device including a light-emitting substrate according to embodiments of the present disclosure. As shown in FIG. 2, the display device includes the light-emitting substrate 100 and a liquid crystal display panel 200. The liquid crystal display panel 200 is located at the light-exiting side of the light-emitting substrate 100. The liquid crystal display panel 200 includes a display region AA and a non-display region NA. The display region AA includes a plurality of sub-pixels (not shown in FIG. 2). The sub-pixel includes a pixel electrode, a common electrode, and liquid crystal. The non-display region NA includes a periphery circuit and an encapsulation structure. For example, the light-emitting region A of the light-emitting substrate 100 is opposite to the display region AA of the liquid crystal display panel 200. The light-emitting substrate 100 serves as the backlight module. When the display device works, the liquid crystal is deflected due to a voltage difference between the pixel electrode and the common electrode, and the light emitted by each light-emitting element 20 of the light-emitting substrate 100 passes though the deflected liquid crystal and exits. When the light-emitting substrate 100 and the liquid crystal display panel 200 are assembled to form the display device 1000, the configuration of the embodiments of the present disclosure can improve the chromaticity uniformity at the edge of the display region of the display device 1000.

For example, as shown in FIG. 1, the first light-emitting element 20 adjacent to the edge light-emitting element 201 is adjacent to the edge S of the light-emitting region A. That means the light-emitting region A includes multiple edge light-emitting elements 201, and two adjacent edge light-emitting elements 201 emit light of different colors. For example, in embodiments of the present disclosure, light emitted by any two adjacent edge light-emitting elements 201 has different colors. With such design, the chromaticity uniformity at the edge S of the light-emitting substrate 100 can be improved just by adjusting the arrangement manner of the light-emitting elements 20 in the light-emitting region A without adding additional light-emitting elements 20 in the light-emitting substrate 100, thereby reducing the manufacturing cost of the light-emitting substrate 100.

In some example embodiments, the arrangement direction of the two adjacent edge light-emitting elements 201 emitting lights of different colors is parallel to the extending direction of the edge S of the light-emitting region A. It should be understood that the light-emitting substrate 100 includes multiple edges extending in different directions. As shown in FIG. 1, the shape of the light-emitting region A is a rectangle. That means the edge S of the light-emitting region A includes a first edge S1 and a second edge S2 that extend in different directions. Schematically, the first edge S1 is parallel to a first direction h1, and the second edge S2 is parallel to a second direction h2. The first direction h1 intersects the second direction h2. When the light-emitting substrate 100 includes edges having different extending directions, as shown in FIG. 1, the configuration that light emitted by two adjacent edge light-emitting elements 201 has different colors includes: the light emitted by two adjacent edge light-emitting elements 201 adjacent to the first edge S1 has different colors, and/or, light emitted by two adjacent edge light-emitting elements 201 adjacent to the second edge S2 has different color.

It should be understood that the shape of the light-emitting substrate shown in FIG. 1 is merely an illustration, the shape of the light-emitting substrate in embodiments of the present disclosure may be a circle or an irregular shape, and the shape of the light-emitting substrate is not limited.

Referring to FIG. 1 again, a plurality of repeated units 4 arranged along the second direction h2 is provided in the light-emitting region A includes, and each repeated unit 4 includes a plurality of light-emitting element groups 10 arranged along the second direction h2. Each light-emitting element group 10 includes a plurality of light-emitting element sub-groups 11 arranged along the first direction h1. Each light-emitting element sub-group 11 includes multiple light-emitting elements 20 that are sequentially arranged along the first direction h1 and configured to emit light of different colors. As shown in FIG. 1, in the light-emitting element sub-group 11, the first color light-emitting element 1, the second color light-emitting element 2, and the third color light-emitting element 3 are sequentially arranged. The arrangement sequence of light-emitting elements 20 configured to emit the light of different colors is not limited in embodiments of the present disclosure. For example, in the light-emitting element sub-group 11, the first color light-emitting element 1, the third color light-emitting element 3, and the second color light-emitting element 2 are sequentially arranged.

In the embodiments of the present disclosure, as shown in FIG. 1, in any two adjacent light-emitting element groups 10, light emitted by two light-emitting elements 20 that are adjacent to each other along the second direction h2 has different colors. Such configuration can improve the chromaticity uniformity at the edge of the light-emitting region A, and can cause the light-emitting elements 20 emitting light of different colors to be dispersedly distributed in a part region of the light-emitting region A, which improves the chromaticity uniformity in the light-emitting region A and avoids the color shift in the light-emitting region A.

In an example embodiment, as shown in FIG. 1, the plurality of repeated units 4 includes a first repeated sub-unit 41 and a second repeated sub-unit 42 arranged along the second direction h2, and each of the first repeated sub-unit 41 and the second repeated sub-unit 42 includes multiple light-emitting element groups 10 arranged along the second direction h2.

Any two adjacent light-emitting element groups 10 of the first repeated sub-unit 41 include a prior light-emitting element group and a later light-emitting element group that are arranged along a direction parallel to the second direction h2 and pointing from the first repeated sub-unit 41 to the second repeated sub-unit 42, and the later light-emitting element group is shifted from respect to the prior light-emitting element group with a first distance d1 along the first direction h1.

Any two adjacent light-emitting element groups 10 of the second repeated sub-unit 42 include a prior light-emitting element group and a later light-emitting element group arranged along the direction parallel to the second direction h2 and pointing from the first repeated sub-unit 41 to the second repeated sub-unit 42, and the later light-emitting element group is shifted from respect to the prior light-emitting element group with a second distance d2 along the first direction h2, where d1≠d2.

In an example embodiment, as shown in FIG. 1, the plurality of repeated units 4 includes a third repeated sub-unit 43. The third repeated sub-unit 43 is located between the first repeated sub-unit 41 and the second repeated sub-unit 42. The third repeated sub-unit 43 is adjacent to each of the first repeated sub-unit 41 the second repeated sub-unit 42. The third repeated sub-unit 43 includes at least one light-emitting element group 10. FIG. 1 shows an example that the third repeated sub-unit 43 includes one light-emitting element group 10 for illustration.

As shown in FIG. 1, along the direction parallel to the second direction h2 and pointing from the first repeated sub-unit 41 to the second repeated sub-unit 42, a first one of the at least one light-emitting element group 10 in the third repeated sub-unit 43 is shifted from respect to a last one of the light-emitting element groups 10 in the first repeated sub-unit 41 with the first distance d1 along the first direction h1. Along the direction parallel to the second direction h2 and pointing from the first repeated sub-unit 41 to the second repeated sub-unit 42, a first one of the light-emitting element groups 10 in the second repeated sub-unit 42 is shifted from respect to a last one of the at least one light-emitting element group 10 in the third repeated sub-unit 41 with the second distance d2 along the first direction h1.

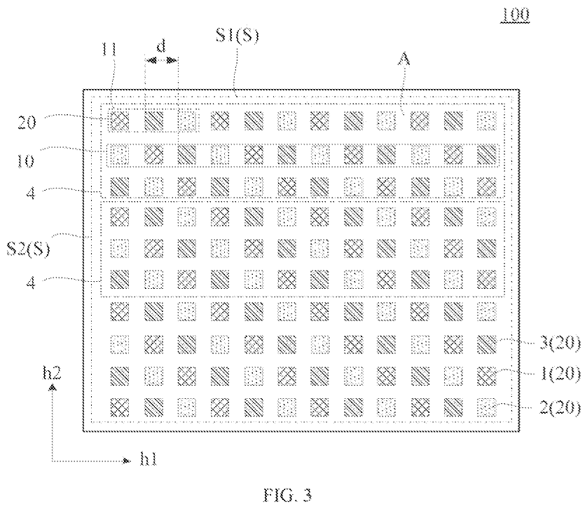

FIG. 3 is a schematic diagram of another light-emitting substrate according to embodiments of the present disclosure. In an embodiment, as shown in FIG. 3, any two adjacent light-emitting element groups 10 in the repeated unit 4 are shifted from a distance d along the first direction h1. With such configuration, the light-emitting elements 20 configured to emit light of different colors are arranged more dispersedly in the light-emitting region A, which improves the chromaticity uniformity in the light-emitting region A. FIG. 3 shows an example for illustration in which the light-emitting element sub-group 11 includes the first color light-emitting element 1, the third color light-emitting element 3, and the second color light-emitting element 2 that are sequentially arranged.

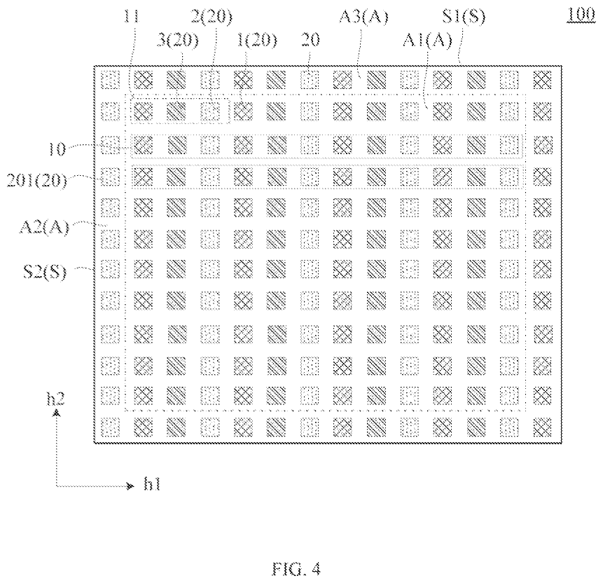

FIG. 4 is a schematic diagram of yet another light-emitting substrate according to embodiments of the present disclosure. In some embodiments, as shown in FIG. 4, the light-emitting region A of the light-emitting substrate 100 includes a first region A1 and a second region A2 adjacent to the first region A1. For example, the second region A2 is located at a side of the first region A1 close to the edge of the light-emitting region A. That means the first region A1 is not adjacent to the edge of the light-emitting region A.

The edge light-emitting element 201 is provided in the second region A2, the first light-emitting element 20 adjacent to the edge light-emitting element 201 is provided in the first region A1, and the first light-emitting element 20 and the edge light-emitting element 201 are configured to emit light of different colors. That is, the first light-emitting element 20 in this embodiment is not adjacent to the edge of the light-emitting region A. In other words, light-emitting elements 20 emitting light different colors are respectively provided at two sides of a boundary between the first region A1 and the second region A2. The light-emitting element 20 in the first region A1 is located at a side of the edge light-emitting element 201 away from the edge S of the light-emitting region A. FIG. 4 shows an example for illustration in which the edge light-emitting element 201 includes the second color light-emitting element 2, and the light-emitting element 20 located in the first region A1 and adjacent to the edge light-emitting element 201 includes the first color light-emitting element 1.

In the light-emitting substrate 100 provided by embodiments of the present disclosure, the light-emitting region A includes the first region A1 and the second region A2, and the second region A2 is located at a side of the first region A1 close to the edge S of the light-emitting region A. The edge light-emitting element 201 is arranged in the second region A2, and the light-emitting element 20 adjacent to the edge light-emitting element 201 and configured to emit light of a color different from the color of light emitted from the edge light-emitting element 201 is located in the first region A1. At the boundary between the first region A1 and the second region A2, the light emitted by the edge light-emitting element 201 compensates the light emitted by the light-emitting element 20 in the first region A1. That means fusion of light of different colors. Compared with a configuration that no edge light-emitting element 201 is provided in the second region A2, the light-emitting substrate 100 of the present disclosure improves the color blending effect at the boundary between the first region A1 and the second region A2, improves the chromaticity uniformity, and avoids the color shift.

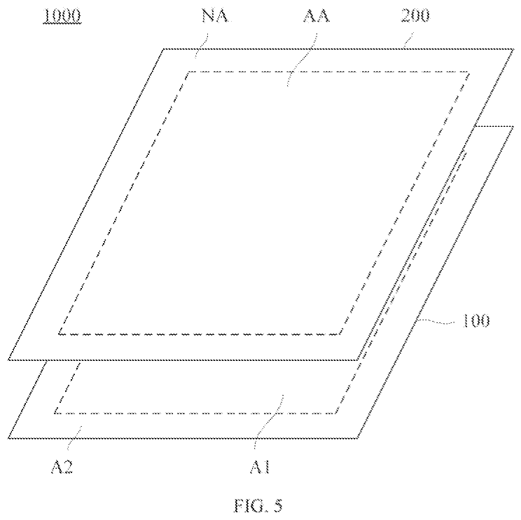

In some embodiments, the light-emitting substrate 100 may be assembled with a liquid crystal display panel to form a display device. FIG. 5 is a schematic diagram of another display device 1000 including a light-emitting substrate 100 according to embodiments of the present disclosure. As shown in FIG. 5, the display device 1000 includes a liquid crystal display panel 200. The liquid crystal display panel 200 is arranged at the light-exiting side of the light-emitting substrate 100. The liquid crystal display panel 200 includes a display region AA and a non-display region NA. Multiple sub-pixels (not shown in FIG. 5) are provided in the display region AA. The sub-pixel includes a pixel electrode, a common electrode, and liquid crystal. A periphery circuit and an encapsulation structure are provided in the non-display region NA. For example, the first region A1 of the light-emitting substrate 100 is opposite to the display region AA of the liquid crystal display panel 200, and the second region A2 of the light-emitting substrate 100 is opposite to the non-display region NA of the liquid crystal display panel 200. That is, no pixel is provided in the region of the liquid crystal display panel 200 corresponding to the second region A2. The light-emitting substrate 100 serves as the backlight module of the display device 1000. When the display device 1000 operates, the liquid crystal is deflected due to a difference between a voltage of the pixel electrode and a voltage of the common electrode, and the light emitted by each light-emitting element 20 of the light-emitting substrate 100 passes though the deflected liquid crystal and exits. When the light-emitting substrate 100 and the liquid crystal display panel 200 are assembled to form the display device 1000, the configuration of the embodiments of the present disclosure can improve the chromaticity uniformity at the edge of the display region AA of the display device 1000, that is, improving the chromaticity uniformity at the boundary between the display region AA and the non-display region NA, thereby avoiding the color shift at the boundary.

In some example embodiments, as shown in FIG. 4, the color of the light emitted by the edge light-emitting element 201 is the same as the color of the light emitted by a light-emitting element 20 located in the first region A1 and not adjacent to the edge light-emitting element 201.

In some embodiments, lights emitted by the light-emitting elements 20 in the first region A1 have N1 colors, N1 being an integer greater than 3. The edge light-emitting element 201 and the light-emitting element 20 located in the first region A1 and emitting light having a color same as the color of light emitted by the edge light-emitting element 201 are spaced apart from each other by at least N2 light-emitting elements 20 emitting light of different colors, where N2=N1−1. With such configuration, it is avoided that the edge light-emitting element 201 is too close to the light-emitting element 20 located in the first region A1 and emitting light having the color same as the color of light emitted by the edge light-emitting element 201, thereby improving the color blending uniformity of the light-emitting substrate 100. FIG. 4 shows an example for illustration in which the edge light-emitting element 201 includes the second color light-emitting element 2. The edge light-emitting element 201 and the second color light-emitting element 2 in the first region A1 are spaced apart from each other by two light-emitting elements 20, and the two light-emitting elements 20 are the first color light-emitting element 1 and the third color light-emitting element 3, respectively.

As shown in FIG. 4, multiple light-emitting element groups 10 arranged along the second direction h2 are located in the first region A1, each light-emitting element group 10 includes multiple light-emitting element sub-groups 11 arranged along the first direction h1, and each light-emitting element sub-group 11 includes multiple light-emitting elements 20 that are arranged along the first direction h1 and that emit lights of different colors. As shown in FIG. 1, in each light-emitting element sub-group 11, the first color light-emitting element 1, the third color light-emitting element 3, and the second color light-emitting element 2 are sequentially arranged. The arranging sequence of the light-emitting elements 20 emitting light of different colors in the light-emitting element sub-group 11 is not limited in embodiments of the present disclosure.

In embodiments of the present disclosure, in any two adjacent light-emitting element groups 10, the light-emitting elements 20 emitting the same color light are arranged along the second direction h2. As shown in FIG. 4, multiple first color light-emitting elements 1 are arranged along the second direction h2, multiple second color light-emitting elements 2 are arranged along the second direction h2, and multiple third color light-emitting elements 3 are arranged along the second direction h2. With such configuration, the light-emitting elements 20 in the first region A1 are arranged more regularly.

In some example embodiments, multiple edge light-emitting elements 201 emitting light of a same color are arranged in the second region A2, and the multiple edge light-emitting elements 201 are arranged along the second direction h2. As shown in FIG. 4, the multiple edge light-emitting elements 201 are all the second color light-emitting elements 2, and the second color light-emitting elements 2 in the second region A2 are arranged along the second direction h2.

In some example embodiments, when the light-emitting substrate 100 is lit, the driving current of the edge light-emitting element 201 adjacent to the edge S of the light-emitting region A is smaller than the driving current of the light-emitting element 20 that is not adjacent to the edge S and emits light of the same color as the edge light-emitting element 201. In this way, a halo phenomenon due to the over large brightness at the edge of the light-emitting substrate 100 is avoided, and the brightness uniformity of different positions of the light-emitting substrate 100 is improved.

In some example embodiments, as shown in FIG. 4, the driving current of the edge light-emitting element 201 is smaller than the driving current of the light-emitting element 20 in the first region A1 and emits light of the same color as the edge light-emitting element 20. In this way, it is avoided that the brightness of the second region A2 is too large, and the brightness uniformity of different positions of the light-emitting substrate 100 is improved.

For example, the edge light-emitting elements 201 include the first color light-emitting element 1, the second color light-emitting element 2, and the third color light-emitting element 3. The driving current I₁₁ of the first color light-emitting element 1 that is not adjacent to the edge S is 1.2 mA, the driving current I₂₁ of the first color light-emitting element 1 adjacent to the edge S of the light-emitting region A satisfies: 0.6 mA≤I₂₁≤1 mA. The driving current I₁₂ of the second color light-emitting element 2 that is not adjacent to the edge S is 0.5 mA, the driving current I₂₂ of the second color light-emitting element 2 adjacent to the edge S of the light-emitting region A satisfies: 0.2 mA≤I₂₂≤0.4 mA. The driving current I₁₃ of the third color light-emitting element 3 that is not adjacent to the edge S is 0.8 mA, the driving current I₂₃ of the third color light-emitting element 3 adjacent to the edge S of the light-emitting region A satisfies: 0.4 mA≤I₂₃≤0.6 mA. In this way, the brightness uniformity of different positions of the light-emitting substrate 100 is improved.

In some embodiments, the edge light-emitting element 201 adjacent to the edge S of the light-emitting region A and the light-emitting element 20 that is not adjacent to the edge S and emits light of the same color as the edge light-emitting element 20 are driven independently, such that the edge light-emitting element 201 and the light-emitting element 20 have different driving currents, and the brightness uniformity of different positions of the light-emitting substrate 100 is improved.

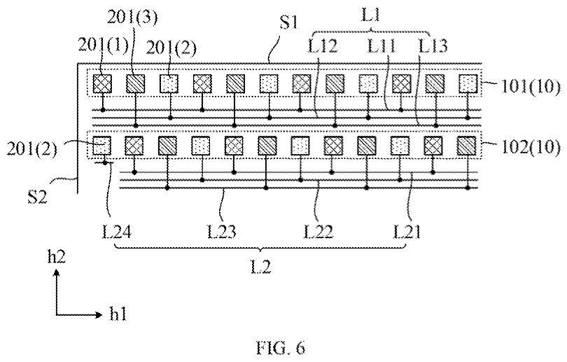

FIG. 6 is a schematic diagram showing electrical connection of a partial area of a light-emitting substrate according to embodiments of the present disclosure. As shown in FIG. 6, the light-emitting element groups 10 that are adjacent to the first edge S1 are electrically connected to a first driving line group L1, and the light-emitting element groups 10 that are not adjacent to the first edge S1 are electrically connected to a second driving line group L2. For convenience of description, the light-emitting element groups 10 that are adjacent to the first edge S1 are referred to as first light-emitting element groups and are denoted by 101 in FIG. 4; and the light-emitting element groups 10 that are not adjacent to the first edge S1 are referred to as second light-emitting element groups, and are denoted by 102 in FIG. 4.

The first driving line group L1 includes a first driving line L11, a second driving line L12, and a third driving line L13. The multiple first color light-emitting elements 1 in the first light-emitting element group 101 are electrically connected to the first driving line L11. The multiple second color light-emitting elements 2 in the first light-emitting element group 101 are electrically connected to the second driving line L12. The multiple third color light-emitting elements 3 in the first light-emitting element group 101 are electrically connected to the third driving line L13.

The second driving line group L2 includes a first driving line L21, a second driving line L22, a third driving line L23, and a fourth driving line L24. The multiple first color light-emitting elements 1 in the second light-emitting element group 102 and not adjacent to the second edge S2 are electrically connected to the first driving line L21. The multiple second color light-emitting elements 2 in the second light-emitting element group 102 and not adjacent to the second edge S2 are electrically connected to the second driving line L22. The multiple third color light-emitting elements 3 in the second light-emitting element group 102 and not adjacent to the second edge S2 are electrically connected to the third driving line L23. The multiple second color light-emitting elements 2 in the second light-emitting element group 102 and adjacent to the second edge S2 are electrically connected to the fourth driving line L24. The fourth driving line L24 and the second driving line L22 are insulated from each other. With such configuration, in embodiments of the present disclosure, the driving lines in the first driving line group L1 supply smaller driving currents to the corresponding light-emitting elements 20 in the first light-emitting element group 101 adjacent to the first edge S1, and the driving lines in the second driving line group L2 supply larger driving currents to the corresponding light-emitting elements 20 in the second light-emitting element group 102 not adjacent to the first edge S1.

The fourth driving line L24 supplies a smaller driving current to the edge light-emitting element 201 in the second light-emitting element group 102 adjacent to the second edge S2, and the second driving line L22 supplies a larger driving current to the second color light-emitting element 2 in the second light-emitting element group 102 that is not adjacent to the second edge S2 and emits light of the same color as the edge light-emitting element 201.

In some example embodiments, each light-emitting element 20 includes a first electrode and a second electrode. The driving line is electrically connected to the first electrode of the light-emitting element 20 or is electrically connected to the second electrode of the light-emitting element 20, which is not limited in embodiments of the present disclosure.

In some example embodiments, as shown in FIG. 4, the first region A1 and the second region A2 are arranged along the first direction h1.

As shown in FIG. 4, the light-emitting substrate 100 includes a third region A3, and the third region A3 and the first region A1 are arranged along the second direction h2. The multiple light-emitting elements 20 emitting light of different colors are provided in the third region A3. In the third region A3, the multiple light-emitting elements 20 emitting lights of different colors are arranged long the first direction h1. The light-emitting elements 20 in the third region A3 can improve the brightness at the boundary between the third region A3 and the first region A1 and improve brightness uniformity of different positions of the light-emitting substrate 100.

In some example embodiments, as shown in FIG. 4, the light-emitting element 20 in the third region A3 and the light-emitting element in the first region A1 and emitting the same color light are arranged along the second direction h2.

In some embodiments, when the light-emitting substrate 100 is lit, the driving current of the light-emitting element 20 in the third region A3 is smaller than the driving current of the light-emitting element 20 in the first region A1 and emitting the same color light. In this way, an over large brightness of the third region A3 is avoided, and the brightness uniformity of different positions of the light-emitting substrate 100 is improved.

Embodiments of the present disclosure provide a display panel including the light-emitting substrate 100. For example, the display panel further includes a driving circuit. When the display panel is operating, under the driving circuit, the light-emitting elements 20 in the light-emitting substrate 100 emit lights independently so as to display a desired image. The structure of the light-emitting substrate 100 has been described in detail in the above embodiments and is not repeated herein.

The display panel provided by embodiments of the present disclosure can improve the chromaticity uniformity at different positions of the display panel. With such configuration, it does not need to provide a backlight module for the display panel. That is, the display panel is a self-illumination display panel, which is beneficial to reducing the thickness of the display panel.

Embodiments of the present disclosure provide a backlight module including the above light-emitting substrate 100. The light-emitting elements in the light-emitting substrate 100 can serve as a backlight source. The backlight mode may be used together with the liquid crystal display panel, so as to display the desired image. The structure of the light-emitting substrate 100 has been described in detail in the above embodiments and is not repeated herein.

The backlight module provided by embodiments of the present disclosure can improve the chromaticity uniformity at different positions of the backlight module. With such configuration, the light-emitting elements 20 in different portions of the light-emitting substrate 100 may emit light in a time-division manner. That is, a local dimming manner is used for the backlight module, which reduces the power consumption of the backlight module.

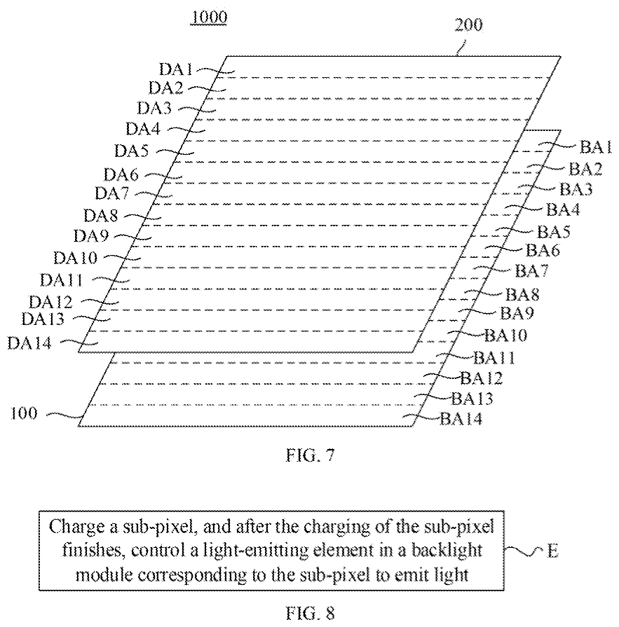

Embodiments of the present disclosure provide a display device. FIG. 7 is a schematic diagram showing layers of a display device 1000 according to embodiments of the present disclosure. As shown in FIG. 7, the display device 1000 includes a liquid crystal display panel 200 and a backlight module. The backlight module includes the light-emitting substrate 100. The liquid crystal display panel 200 is located at the light-exiting side of the light-emitting substrate 100. The structure of the light-emitting substrate 100 has been described in detail in the above embodiments and is not repeated herein. The display device 1000 shown in FIG. 7 is an example for illustration. The display device 1000 may be, for example, a mobile phone, a tablet computer, a laptop, a paper book, a television, or other electronic devices having a display function.

In some example embodiments, the liquid crystal display panel 200 includes a plurality of scan lines (not shown), a plurality of data lines (not shown), and a plurality of sub-pixels. The sub-pixel includes a switching transistor, a pixel electrode, a common electrode, and a liquid crystal. The scan line is electrically connected to a gate electrode of the switching transistor. The data line is electrically connected to a first electrode of the switching transistor. The pixel electrode is electrically connected to a second electrode of the switching transistor. When the liquid crystal display panel 200 is operating, the plurality of scan lines supplies enable signals sequentially. Under the enable signal provided by the scan line, the corresponding sub-pixel is charged. In the charging process of the sub-pixel, the switching transistor is turned on, and a data voltage provided by the data line is inputted to the pixel electrode through the turned-on switching transistor. The liquid crystal is deflected under the voltage difference between the pixel electrode and the common electrode. The light emitted by each light-emitting element 20 in the light-emitting substrate 100 passes through the deflected liquid crystal and exits. With the arrangement of the present disclosure, the chromaticity uniformity at the edge of the display region of the display device 1000 can be improved.

Embodiments of the present disclosure further provide a method for driving the display device 1000. The liquid crystal display panel 200 includes a plurality of sub-pixels (not shown in FIG. 7). FIG. 8 is a flowchart of a method for driving a display device 1000 according to embodiments of the present disclosure. As shown in FIG. 7 and FIG. 8, the driving method includes a step E.

At step E, the sub-pixel is charged, and after the charging of the sub-pixel finishes, the light-emitting element in the backlight module corresponding to the sub-pixel is controlled to emit light.

Based on the above method provided by embodiments of the present disclosure, it is avoided that the light emitted by the backlight module exits through passing through the liquid crystal molecule that is not deflected to the target position, and the normal display of the display device is ensured.

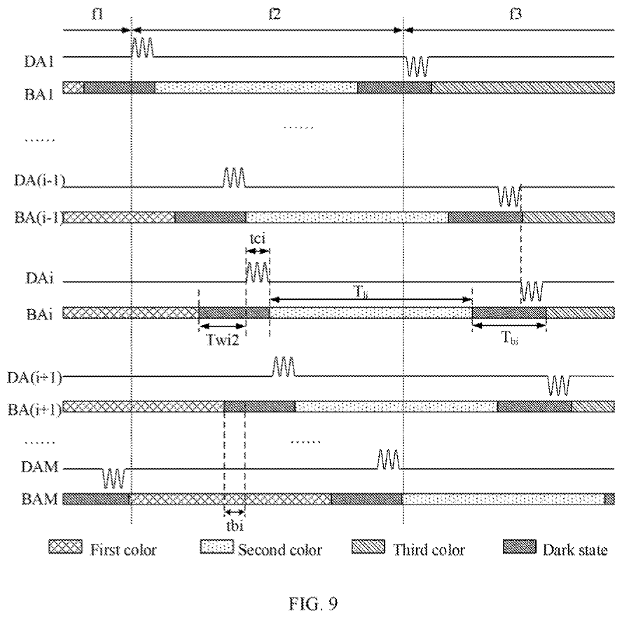

FIG. 9 is a schematic diagram showing a working principle of backlight partitions and display partitions corresponding to the backlight partitions of a display panel according to embodiments of the present disclosure. In some embodiments, as shown in FIG. 7 and FIG. 9, the liquid crystal display panel 200 includes M display partitions, where M is an integer greater than 4. FIG. 7 shows an example where M=14. The liquid crystal display panel 200 includes a first display partition DA1, a second display partition DA2, . . . , a thirteenth display partition DA13, and a fourteenth display partition DA14 that are sequentially arranged according to a scanning sequence of the liquid crystal display panel 200. Multiple sub-pixels (not shown) are provided in each display partition.

The backlight module including the light-emitting substrate 100 includes M backlight partitions. FIG. 7 shows an example that the backlight module includes a first backlight partition BA1, a second backlight partition BA2, . . . , a thirteenth backlight partition BA13, and a fourteenth backlight partition BA14 that are sequentially arranged according to a scanning order of the liquid crystal display panel 200. The backlight partitions in the backlight module and the display partitions in the liquid crystal display panel 200 are in one-to-one correspondence. That means the light emitted by the first backlight partition BA1 passes through the first display partition DA1 and exits, the light emitted by the second backlight partition BA2 passes through the second display partition DA2 and exits the light emitted by the thirteenth backlight partition BA13 passes through the thirteenth display partition DA13 and exits; and the light emitted by the fourteenth backlight partition BA14 passes through the fourteenth display partition DA14 and exits. In the embodiments of the present disclosure, each backlight partition includes light-emitting elements emitting lights of multiple colors.

In the embodiments of the present disclosure, an image display frame of the display device includes at least two sub-frames. The starting time point of each sub-frame is the time point that the charging of the first display partition DA1 starts, where the first display partition DA1 is charged by a voltage corresponding to the current sub-frame. The ending time point of each sub-frame is the time point that the charging of the Mth display partition DAM ends, where the Mth display partition DAM is charged by a voltage corresponding to the current sub-frame. FIG. 8 only shows the first display partition DA1, the (i−1)th display partition DA(i−1), the i^{th} display partition Dai, the (i+1)th display partition DA(i+1), and the Mth display partition DAM, and backlight partitions corresponding to these display partitions, other display partitions and their backlight partitions are omitted. FIG. 8 shows an example that one image display frame includes a first sub-frame f1, a second sub-frame f2, and a third sub-frame f3. In embodiments of the present disclosure, the step E of charging the sub-pixel and controlling the light-emitting element in the backlight module corresponding to the sub-pixel to emit light after the charging of the sub-pixel is completed includes the following step.

In each sub-frame, the plurality of display partitions is charged sequentially according to the scanning sequence of the liquid crystal display panel 200, and after the charging processes of the plurality of display partitions with voltages corresponding to the current sub-frame finishes, each of the backlight partitions is controlled to emit light of the color corresponding to the current sub-frame. In the embodiments of the present disclosure, the same backlight partition emits lights of different colors in two adjacent sub-frames.

In embodiments of the present disclosure, after the light-emitting process of the backlight partition with the color corresponding to the sub-frame finishes, the display partition corresponding to the backlight partition is charged with the voltage corresponding to the next sub-frame.

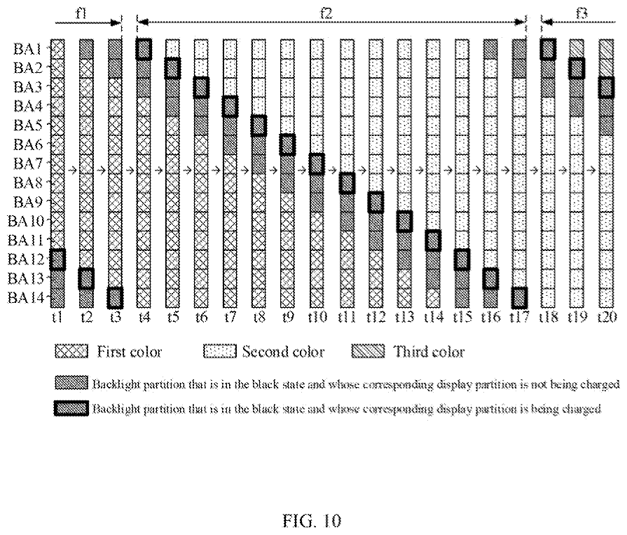

For example, the backlight partition emits light of the first color in the first sub-frame f1, emits light of the second color in the second sub-frame f2, and emits light of the third color in the third sub-frame f3, where the first color, the second color, and the third color are different from each other. FIG. 10 is a schematic diagram showing color changing of backlight partitions of a backlight module in multiple time periods according to embodiments of the present disclosure. As shown in FIG. 9 and FIG. 10, in embodiments of the present disclosure, for any backlight partition, the color of the light emitted by the backlight partition is switched between the first color, the second color, and the third color with a high frequency. Utilizing an integral effect in a time direction of the eyes, a colorful image can be visible by the user. In some embodiments, the brightness of the first color, the brightness of the second color, and the brightness of the third color are adjusted so as to obtain various color expressions. Based on the arrangement of embodiments of the present disclosure, there is no need to provide a color filter layer in the liquid crystal display panel 200, which is beneficial to improving the resolution of the display device 1000 and reducing the manufacturing cost of the display device 1000.

In some example embodiments, as shown in FIG. 9, the charging voltage of the same display partition has opposite polarities in two adjacent sub-frames, such that the liquid crystal molecule in this display partition is deflected in different directions in the two adjacent sub-frames, avoiding curing of the liquid crystal.

In embodiments of the present disclosure, in the charging period of the display partition, the backlight partition corresponding to the display partition is in a dark state (non-emitting state). The dark state refers to a state that the backlight partition does not emit light. FIG. 9 shows an example of the i^{th} display partition DAi. In the charging period tci of the i^{th} display partition DAi, the i^{th} backlight partition BAi is in the dark state. Such configuration can avoid that the light emitted by the backlight module exits by passing through the liquid crystal molecule that is not reflected to the target position, ensuring the normal display of the display device 1000. Accordingly, when the backlight partition is in the emitting state, the display partition corresponding to the backlight partition is not being charged. The emitting state refers to a state that the backlight partition is emitting light.

In embodiments of the present disclosure, the periods during which at least two adjacent backlight partitions of the M backlight partitions are in the dark state partially overlap. That means in the overlapping period, at least two backlight partitions are in the dark state. FIG. 9 shows an example. In the time period tbi, the (i−1)th backlight partition BA(i−1), the i^{th} backlight partition BAi, and the (i+1)^{th} backlight partition BA(i+1) are all in the dark state.

In the embodiments of the present disclosure, in a part of the working period of the display device, backlight partitions located at two sides of a black-state backlight partition emit lights of different colors. As shown in FIG. 10, from the time period t5 to the time period t14, backlight partitions located at two sides of a dark-state backlight partition emit lights of different colors. For example, during the time period t5, the first backlight partition BA1 emits light of the second color; the second backlight partition BA2, the third backlight partition BA3, and the fourth backlight partition BA4 are in the dark state; and the fifth backlight partition BA5 to the fourteenth backlight partition BA14 emit lights of the first color. During the time period t8, the first backlight partition BA1 to the fourth backlight partition BA4 emit lights of the second color; the fifth backlight partition BA5 to the seventh backlight partition BA7 are all in the dark state; and the eighth backlight partition BA8 to the fourteenth backlight partition BA14 emit lights of the first color.

In embodiments of the present disclosure, the state periods during which at least two adjacent backlight partitions are in the dark state partitions overlap. In the overlapping period, the backlight partitions emitting lights of different colors are spaced apart by at least two backlight partitions that are in the dark state. In this way, color blending of backlight partitions emitting lights of different colors is avoided, mutual interference between halos of different colors is avoided, and display effect of the display panel is improved.

In some example embodiments, the maximum value of the number of the backlight partitions (periods during which these backlight partitions are in the black state overlap) is determined according to the area of the backlight partition and the region affected by the halo of the backlight partition, which is not limited in embodiments of the present disclosure.

In some example embodiments, the continuous duration the backlight partition being in the dark state is smaller than or equal to the continuous duration the backlight partition being in the emitting state. As shown in FIG. 9, the continuous duration the i^{th} backlight partition being in the dark state is T_{bi}, and the continuous duration the i^{th} backlight partition being in the emitting state is Tₗᵢ, and T_{bi}≤Tₗᵢ, so as to ensure the colorful display effect of the display device.

In some example embodiments, the same backlight partition emits lights of colors corresponding to different sub-frames with a same continuous duration. As shown in FIG. 9, the continuous duration of the i^{th} backlight partition emitting light of the first color in the first sub-frame f1, the continuous duration of the i^{th} backlight partition emitting light of the second color in the second sub-frame f2, and the continuous duration of the i^{th} backlight partition emitting light of the third color in the third sub-frame f3 are all equal to Tₗᵢ.

In some example embodiments, the step of after the charging process of the display partition with the voltage corresponding to the current sub-frame finishes, controlling the backlight partition corresponding to the display partition to emit light of the color corresponding to the current sub-frame includes: after a first waiting period after the charging process of the display partition with the voltage corresponding to the current sub-frame finishes, the backlight partition corresponding to the display partition emits light of the color corresponding to the current sub-frame. During the first waiting period, the backlight partition corresponding to the display partition is in the dark state.

With such configuration, during the first waiting period, at least one display partition that is adjacent to the charged display partition and follows the charged display partition in the scanning order of the liquid crystal display panel is charged with the voltage corresponding to the current sub-frame. Accordingly, the backlight partition corresponding to the next display partition adjacent to the charged display partition is in the dark state.

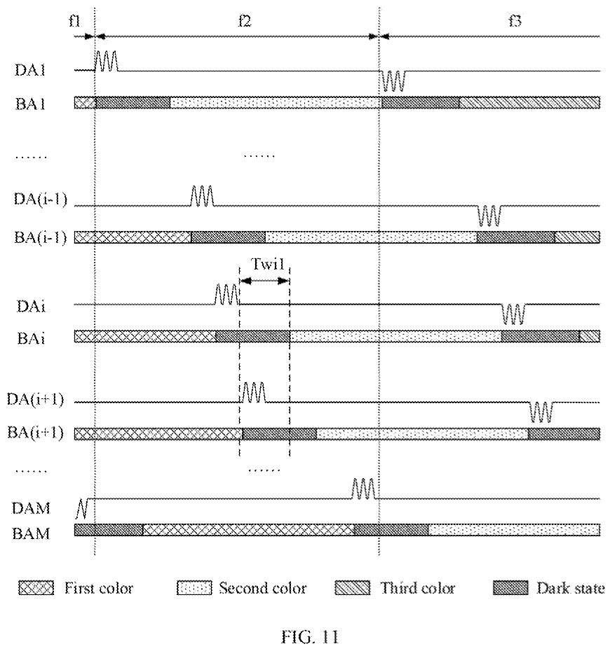

Such configuration is described with the i^{th} backlight partition and the (i+1)^{th} backlight partition as examples. FIG. 11 is a schematic diagram showing a working principle of backlight partitions and display partitions corresponding to the backlight partitions according to embodiments of the present disclosure. As shown in FIG. 11, after the charging process of the i^{th} display partition with the voltage corresponding to the second sub-frame ends, the i^{th} backlight partition waits for the first waiting period Twi1 and then emits light of the color corresponding to the second sub-frame. In the first waiting period Twi1, the i^{th} backlight partition is in the dark state, the (i+1)^{th} display partition DA(i+1) is charged with the voltage corresponding to the second sub-frame, and the i^{th} backlight partition and the (i+1)^{th} backlight partition are both in the dark state.

The configuration of the first waiting period can avoid the mutual interference between light of different colors emitted by different backlight partitions, and also increase the time spacing between the charging of the display partition and the light-emitting of the backlight partition. In this way, it is avoided that the light emitted by the backlight partition exits the display panel by passing through the liquid crystal molecule that is not deflected to the target angle, and the normal display of the display device is ensured.

In another embodiment, the step of after the backlight partition emits light of the current sub-frame, charging the display partition corresponding to the backlight partition with the voltage of the next sub-frame includes: after a second waiting period after the light emitting of the backlight partition with the color of the current sub-frame finishes, the display partition corresponding to the backlight partition is charged by the voltage of the next sub-frame, and during the second waiting period, the backlight partition corresponding to the display partition is in the dark state.

With such configuration, in a part of the second waiting period, at least a prior display partition that is adjacent to this display partition and is charged for the current sub-frame before the charging of this display partition for the current sub-frame according to the scanning order of the liquid crystal display panel is charged by the voltage of the next sub-frame. Accordingly, the backlight partition corresponding to the at least a prior display partition adjacent to this display partition is in the dark state. That is, during the second waiting period, the backlight partition corresponding to the display partition that is being changed and the backlight partition corresponding to the display partition whose charging process follows the display partition that is being changed are both in the dark state. In this way, the mutual interference of lights of different colors emitted by different backlight partitions is avoided.

The above configuration is described with the (i−1)^{th} backlight partition and the i^{th} backlight partition as examples. As shown in FIG. 9, after the light-emitting of the i^{th} backlight partition BAi with the first color corresponding to the first sub-frame f1 ends, the i^{th} display partition DAi waits for the second waiting period Twi2 and then is charged by the voltage corresponding to the second sub-frame f2. In a part of the second waiting period Twi2, the (i−1)^{th} display partition DA(i−1) is charged by the voltage corresponding to the second sub-frame f2, and the (i−1)^{th} backlight partition and the i^{th} backlight partition are both in the dark state.

In another embodiment, the step of after the charging process of the display partition with the voltage corresponding to the current sub-frame finishes, controlling the backlight partition corresponding to the display partition emits light of the color corresponding to the current sub-frame includes: after the first waiting period after the charging process of the display partition with the voltage corresponding to the current sub-frame finishes, the backlight partition corresponding to the display partition emits light of the color corresponding to the current sub-frame. During the first waiting period, the backlight partition corresponding to the display partition is in the dark state.

The step of the light-emitting of the backlight partition with the color corresponding to the current sub-frame finishes, charging the display partition corresponding to the backlight partition by the voltage corresponding to the next sub-frame includes: after the second waiting period after the light-emitting of the backlight partition with the color corresponding to the current sub-frame finishes, the display partition corresponding to the backlight partition is charged by the voltage corresponding to the next sub-frame. During the second waiting period, the backlight partition corresponding to the display partition is in the dark state.

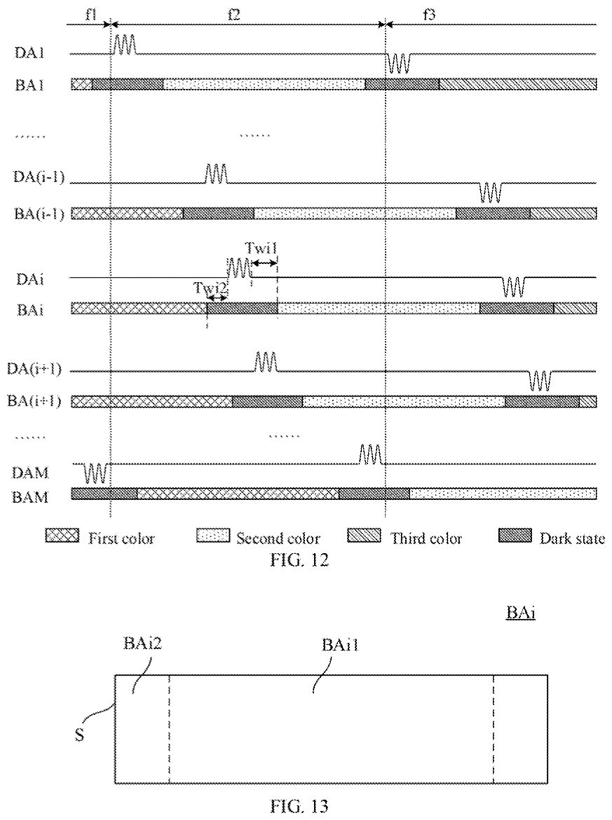

FIG. 12 is a schematic diagram showing a working principle of backlight partitions and display partitions corresponding to the backlight partitions according to embodiments of the present disclosure. The (i−1)^{th} backlight partition, the i^{th} backlight partition, and the (i+1)^{th} display partition are used as examples. As shown in FIG. 12, after the light-emitting of the i^{th} backlight partition BAi with the first color of the first sub-frame f1 ends, the i^{th} display partition DAi waits for the second waiting period Twi2 and then is charged by the voltage of the second sub-frame f2. In a part of the second waiting period Twi2, the (i−1)^{th} display partition DA(i−1) is charged by the voltage of the second sub-frame f2, and the i^{th} backlight partition and the (i−1)^{th} backlight partition are both in the dark state.

After the charging process of the i^{th} display partition with the voltage of the second sub-frame f2 finishes, the i^{th} backlight partition waits for the first waiting period Twi1 and then emits light of the color of the second sub-frame f2. In the first waiting period Twi1, the i^{th} backlight partition BAi is in the dark state, the (i+1)^{th} display partition DA(i+1) is charged by the voltage of the second sub-frame f2, and the i^{th} backlight partition BAi and the (i+1)^{th} backlight partition BA(i+1) are both in the dark state.

In some embodiments, the step of according to the scanning order of the liquid crystal display panel 200, causing the backlight partitions corresponding to the display partitions to sequentially emit lights of colors corresponding to the current sub-frame is as follows. For any backlight partition, within a black-state duration between two emitting time durations with different colors, M1 display partitions are charged; and in a continuous emitting duration, M2 display partitions are charged, and M1+M2=M, where M1 and M2 are both integers.

In the example embodiment shown in FIGS. 10, M=14, M1=3, and M2=11. The fourth backlight partition BA4 shown in FIG. 10 is taken as an example. The fourth backlight partition BA4 is in the emitting state from the time period t1 to the time period t3. In some embodiments of the present disclosure, from the time period t1 to the time period t3, the twelfth display partition (not shown) to the fourteenth display partition (not shown) are charged with their voltage corresponding to the first sub-frame f1. In the time period t4, the fourth backlight partition BA4 is in the emitting state, and the first display partition (not shown) is charged with the voltage corresponding to the second sub-frame f2. From the time period t5 to the time period t7, the fourth display partition BA4 is in the dark state, and the second display partition (not shown) to the fourth display partition (not shown) are sequentially charged with their voltages corresponding to the second sub-frame f2. From the time period t8 to the time period t17, the fourth backlight partition BA4 is in the emitting state, and the fifth display partition (not shown) to the fourteenth partition (not shown) are charged with their voltages corresponding to the second sub-frame f2. In the time period t18, the fourth backlight partition BA4 is in the emitting state, the first display partition (not shown) is charged with the voltage corresponding to the third sub-frame f3. In the time period t19 and time period t20, the fourth backlight partition BA4 is in the dark state, and the second display partition (not shown) and the third display partition (not shown) are charged with their voltages corresponding to the third sub-frame f3.

With such configuration, the time periods in which the backlight partition is in different states are fully utilized to perform the charging processes of different display partitions. In this way, the mutual interference of colors of lights emitted by different backlight partitions is avoided, there is no need to arrange an additional sub-frame, the image refresh rate of the display device is improved, the switching frequency of colors of the light emitted by the backlight is ensured, and the colorful display effect of the display device is ensured.

In some example embodiments, as shown in FIG. 7, the driving method further includes: partitioning the liquid display panel 200 into a plurality of display partitions having a same area and partitioning the backlight module into a plurality of backlight partitions having a same area. With such configuration, the plurality of display partitions and the plurality of backlight partitions can achieve better collaborative operation.

For example, when the plurality of display partitions has a same area, the plurality of display partitions is configured to have a same charging time. Accordingly, in one sub-frame, the plurality of backlight partitions is configured to have a same black-state continuous duration.

In some embodiments, the plurality of display partitions has different areas. For example, the plurality of display partitions is sequentially charged according to the scanning order of the display panel 200, and the areas of the plurality of display partitions are in a sequentially increasing arrangement. That means the quantities of pixel rows of the plurality of display partitions are in a sequentially increasing arrangement. In some other embodiments, the areas of the plurality of display partitions decrease sequentially. That means the quantities of pixel rows of the plurality of display partitions decrease sequentially.

In some example embodiments, the step E of charging the sub-pixel and after the charging process of the sub-pixel ends, controlling the light-emitting element in the backlight module corresponding to the sub-pixel to emit light is as follows.

The driving current of the edge light-emitting element is smaller than the driving current of the light-emitting element that is not adjacent to the edge and emits light of the same color as the edge light-emitting element, so as to improve the brightness uniformity at different positions of the light-emitting substrate 100.

In some example embodiments, the backlight module is partitioned into a plurality of backlight partitions, such that the local dimming can be applied to the backlight module. At least one of the plurality of backlight partitions includes a first backlight sub-partition and a second backlight sub-partition, and the second backlight sub-partition is located at one side of the first backlight sub-partition close to the edge of the light-emitting substrate 100. The above edge light-emitting element is located in the second backlight sub-partition. FIG. 13 is a schematic diagram of the i^{th} backlight partition BAi of a backlight module according to embodiments of the present disclosure. As shown in FIG. 13, the i^{th} backlight partition BAi includes a first backlight sub-partition BAi1 and a second backlight sub-partition BAi2. The second backlight sub-partition BAi2 includes the edge light-emitting element (not shown). The configuration that the driving current of the edge light-emitting element is smaller than the driving current of the light-emitting element that is not adjacent to the edge and emits light of the same color as the edge light-emitting element is as follows.

The driving current of the light-emitting element in the second backlight sub-partition is smaller than the driving current of the light-emitting element that is in the first backlight sub-partition and emits light of the same color as the light-emitting element in the second backlight sub-partition. If the driving current of the light-emitting element in the second backlight sub-partition is equal to the driving current of the light-emitting element that is in the first backlight sub-partition and emits light of the same color, the brightness of the edge of the light-emitting substrate 100 may be greater than the brightness of other positions of the light-emitting substrate 100, and a halo phenomenon may occur at the edge of the light-emitting substrate 100 accordingly. This is because the second backlight sub-partition is closer to the edge of the light-emitting substrate 100. In embodiments of the present disclosure, the driving current of the light-emitting element in the second backlight sub-partition is smaller than the driving current of the light-emitting element in the first backlight sub-partition and emitting light of the same color. In this way, an over large brightness of the second backlight sub-partition that is arranged close to the edge S of the light-emitting substrate 100 is avoided, and the brightness uniformity of different positions of the same backlight partition is improved.

The above illustrates only exemplary embodiments of the present disclosure and is not intended to limit the present disclosure. Any modifications, equivalent replacements, improvements, and the like made within the principle of the present disclosure are intended to fall within the scope of the present disclosure.

What is claimed is:

1. A light-emitting substrate, having a light-emitting region and comprising a plurality of light-emitting elements located in the light-emitting region,
wherein the plurality of light-emitting elements is configured to emit light of different colors; and
wherein the plurality of light-emitting elements comprises at least one edge light-emitting element adjacent to an edge of the light-emitting region, and a first light-emitting element adjacent to one edge light-emitting element of the at least one edge light-emitting element,
wherein the edge light-emitting element is configured to emit light of a first color, and the first light-emitting element is configured to emit light of a second color different from the first color.

2. The light-emitting substrate according to claim 1, wherein the first light-emitting element is adjacent to the edge of the light-emitting region.

3. The light-emitting substrate according to claim 2, wherein:
a plurality of repeated units arranged along a second direction is provided in the light-emitting region,
each repeated unit of the plurality of repeated units comprises a plurality of light-emitting element groups arranged along the second direction,
each of the plurality of light-emitting element groups comprises a plurality of light-emitting element sub-groups arranged along a first direction,
each of the plurality of light-emitting element sub-groups comprises at least two light-emitting elements of the plurality of light-emitting elements that are arranged along the first direction, wherein one of the at least two light-emitting elements is configured to emit a color distinct from a color of light emitted by another one of the at least two light-emitting elements, and
the first direction intersects the second direction.

4. The light-emitting substrate according to claim 3, wherein one of two adjacent light-emitting elements of the plurality of light-emitting elements that are respectively located in two adjacent light-emitting element groups of the plurality of light-emitting element groups and that are arranged along the second direction is configured to emit light of a color different from a color of light emitted by another one of the two adjacent light-emitting elements.

5. The light-emitting substrate according to claim 4, wherein one repeated unit of the plurality of repeated units comprises:
a first repeated sub-unit and a second repeated sub-unit arranged that are arranged along the second direction, wherein each of the first repeated sub-unit and the second repeated sub-unit comprises at least two light-emitting element groups of the plurality of light-emitting element groups the at least two light-emitting element groups being arranged along the second direction; and
wherein in a direction that is parallel to the second direction and points from the first repeated sub-unit to the second repeated sub-unit, a later light-emitting element group of each two adjacent light-emitting element groups of the at least two light-emitting element groups of the first repeated sub-unit is shifted from a first distance d1 along the first direction with respect to a prior light-emitting element group of the two adjacent light-emitting element groups of the at least two light-emitting element groups of the first repeated sub-unit; and
along the direction that is parallel to the second direction and points from the first repeated sub-unit to the second repeated sub-unit, a later light-emitting element group of each two adjacent light-emitting element groups of the at least two light-emitting element groups of the second repeated sub-unit is shifted a second distance d2 along the first direction with respect to a prior light-emitting element group of the two adjacent light-emitting element groups of the at least two light-emitting element groups of the second repeated sub-unit, where d1≠d2.

6. The light-emitting substrate according to claim 5, wherein the one repeated unit of the plurality of units further comprises a third repeated sub-unit located between the first repeated sub-unit and the second repeated sub-unit and adjacent to each of the first repeated sub-unit and the second repeated sub-unit,
wherein the third repeated sub-unit comprises at least one light-emitting element group of the plurality of light-emitting element groups,
wherein along the direction that is parallel to the second direction and points from the first repeated sub-unit to the second repeated sub-unit, a first one of the at least one light-emitting element group of the third repeated sub-unit is shifted from a first distance d1 along the first direction with respect to a last one of the at least two light-emitting element groups of the first repeated sub-unit, and
wherein along the direction that is parallel to the second direction and points from the first repeated sub-unit to the second repeated sub-unit, a first one of the at least two light-emitting element groups of the second repeated sub-unit is shifted from a second distance d2 along the first direction with respect to a last one of the at least one light-emitting element group of the third repeated sub-unit.

7. The light-emitting substrate according to claim 4, wherein each two adjacent light-emitting element groups of the plurality of light-emitting element groups are shifted from each other with a distance d along the first direction.

8. The light-emitting substrate according to claim 1, wherein the light-emitting region comprises a first region and a second region adjacent to the first region, wherein the second region is located at a side of the first region close to the edge of the light-emitting region, and
wherein the edge light-emitting element is disposed in the second region, and the first light-emitting element is disposed in the first region.

9. The light-emitting substrate according to claim 8, wherein the plurality of light-emitting elements comprises a second light-emitting element located in the first region and not adjacent to the edge light-emitting element, wherein the edge light-emitting element and the second light-emitting element are configured to emit light of a same color.

10. The light-emitting substrate according to claim 9, wherein the plurality of light-emitting elements comprises at least two light-emitting elements located in the first region and configured to emit light of N1 colors, wherein the edge light-emitting element is spaced apart from one light-emitting element of the at least two light-emitting elements that is configured to emit light of a same color as the edge light-emitting element, by at least N2 light-emitting elements emitting lights of the at least two light-emitting elements that are configured to emit light of a color different from the color of light emitted by the edge light-emitting element, and N2=N1-1, where N1 is an integer greater than or equal to 3.

11. The light-emitting substrate according to claim 8, wherein a plurality of light-emitting element groups is arranged in the first region along a second direction,
wherein each of the plurality of light-emitting element groups comprises light-emitting element sub-groups arranged along a first direction, and
wherein each of the light-emitting element sub-groups comprises at least two light-emitting elements of the plurality of light-emitting elements that are arranged along the first direction and that are configured to emit light of different colors, the first direction intersecting the second direction, and
wherein at least two of the plurality of light-emitting elements respectively located in each two adjacent light-emitting element groups of the plurality of light-emitting element groups are configured to emit light of a same color and arranged along the second direction.

12. The light-emitting substrate according to claim 11, wherein the at least one edge light-emitting element comprises a plurality of edge light-emitting elements located in the second region, wherein the plurality of edge light-emitting elements comprises at least two edge light-emitting elements arranged along the second direction and configured to emit light of a same color.

13. The light-emitting substrate according to claim 11, wherein the light-emitting region further comprises a third region, wherein the first region and the third region are arranged along the second direction, and
wherein another at least two light-emitting elements of the plurality of light-emitting elements are configured to emit light of a different color from one another, and are arranged in the third region along the first direction.

14. The light-emitting substrate according to claim 13, wherein at least one light-emitting element of the another at least two light-emitting elements in the third region and at least one light-emitting element of the light-emitting elements in the plurality of light-emitting element groups in the first region are configured to emit light of a same color and are arranged along the second direction.

15. The light-emitting substrate according to claim 1, wherein the plurality of light-emitting elements comprises a second light-emitting element not adjacent to the edge of the light-emitting region and configured to emit light of a same color as one of the at least one edge light-emitting element, wherein the one of the at least one edge light-emitting element has a driving current smaller than a driving current of the second light-emitting element.

16. The light-emitting substrate according to claim 1, wherein the plurality of light-emitting elements comprises a first color light-emitting element, a second color light-emitting element, and a third color light-emitting element.

17. A display device, comprising:
a backlight module; and
a liquid crystal display panel located at a light-exiting side of the backlight module,
wherein the light-emitting substrate has a light-emitting region and comprises a plurality of light-emitting elements located in the light-emitting region,
wherein the plurality of light-emitting elements is configured to emit light of different colors; and
wherein the plurality of light-emitting elements comprises at least one edge light-emitting element adjacent to an edge of the light-emitting region, and a first light-emitting element adjacent to one edge light-emitting element of the at least one edge light-emitting element, wherein the edge light-emitting element is configured to emit light of a first color, and the first light-emitting element is configured to emit light of a second different from the first color.

18. A method for driving a display device, wherein the display device comprises a backlight module and a liquid crystal display panel located at a light-exiting side of the backlight module, wherein the backlight module comprises a light-emitting substrate, wherein the light-emitting substrate has a light-emitting region and comprises a plurality of light-emitting elements located in the light-emitting region, wherein the plurality of light-emitting elements comprises at least one edge light-emitting element adjacent to an edge of the light-emitting region, and a first light-emitting element adjacent to one edge light-emitting element of the at least one edge light-emitting element, wherein the edge light-emitting element is configured to emit light of a first color, and the first light-emitting element is configured to emit light of a second color different from the first color, wherein the liquid crystal panel comprises a plurality of sub-pixels, and
wherein the method comprises:
charging one sub-pixel of the plurality of sub-pixels, and after the charging of the sub-pixel finishes, and
controlling one light-emitting element of the plurality of light-emitting elements in the backlight module corresponding to the sub-pixel to emit light.

19. The method according to claim 18, wherein the liquid crystal display panel has M display partitions, and at least two sub-pixels of the plurality of sub-pixels are provided in each of the display partitions, M being an integer greater or equal to 4; the light-emitting substrate has M backlight partitions that are in one-to-one correspondence with the M display partitions, and at least two light-emitting elements of the plurality of light-emitting elements are provided in each of the M backlight partitions, the at least two light-emitting elements being configured to emit light of different colors;
an image display frame of the display device comprises at least two sub-frames;
said charging the sub-pixel of the plurality of sub-pixels, and after the charging of the sub-pixel finishes, said controlling the light-emitting element of the plurality of light-emitting elements in the backlight module corresponding to the sub-pixel to emit light comprise:
during a current sub-frame of the at least two sub-frames, charging each display partition of the M display partitions,
after the charging of the display partition with a voltage corresponding to the current sub-frame finishes, controlling one backlight partition of the M backlight partitions corresponding to the display partition to emit light of a color corresponding to the current sub-frame; and
after the backlight partition emits light of the color corresponding to the current sub-frame, charging the display partition corresponding to the backlight partition with a voltage corresponding to a next sub-frame of the at least two sub-frames,
wherein the backlight partition is configured to emit light of different colors in two adjacent sub-frames of the at least two sub-frames;
at least during the charging of the display partition, the backlight partition corresponding to the display partition is in a dark state; and
periods during which at least two adjacent backlight partitions of the M backlight partitions are in the dark state partially overlap.

20. The method according to claim 19, wherein after the charging of the display partition with the voltage corresponding to the current sub-frame finishes, said controlling the backlight partition of the M backlight partitions corresponding to the display partition to emit light of the color corresponding to the current sub-frame comprises:
after a first waiting period after the charging of the display partition with the voltage corresponding to the current sub-frame finishes, controlling the backlight partition corresponding to the display partition to emit light of the color corresponding to the current sub-frame, wherein, during the first waiting period, the backlight partition corresponding to the display partition is in the dark state, or
after the backlight partition emits light of the color corresponding to the current sub-frame, said charging the display partition corresponding to the backlight partition with the voltage corresponding to the next sub-frame comprises:
after a second waiting period after the light-emitting of the backlight partition with the color corresponding to the current sub-frame finishes, charging the display partition corresponding to the backlight partition with the voltage corresponding to the next sub-frame,
wherein during the second waiting period, the backlight partition corresponding to the display partition is in the dark state.
